(19) United States
(12) Patent Application Publication
(10) Pub. No.: US 2010/0290229 A1
(43) Pub. Date: Nov. 18, 2010

(54) Field adjustable lighting fixture

(75) Inventors: Brent Stephen Meyer, SR., Rancho Palos Verdes, CA (US); James Michael Stanton, Lansdale, PA (US); David Glover, Aqua Dulce, CA (US)

Correspondence Address: BRENT MEYER;C/O THE NASSAU GROUP, LIMITED, P.O. BOX 3484, PALOS VERDES PENISULA, CA, 90274-9484, US

(73) Assignee: The Nassau Group, Limited & DOG Design, Inc.

(21) Appl. No.: 12/800,436

(22) Filed: May 14, 2010

Related U.S. Application Data
(60) Provisional application No. 61/216,160, filed on May 14, 2009.

(51) Int. Cl. F21V 17/02

(52) U.S. Cl. 362/282

(57) ABSTRACT

The adjustable design is defined by examining the current residential & commercial market. To provide beamspread* flexibility of a 12V, 24V, 120V, 240V and 277V AC 50-60 HZ and 12V & 24V DC recessed or surface mounted fixture per drawing FALF dated 13-MAY-2009 (attached to provisional application) which may include all or in part the following:

A. Housing

B. Light source

C. Optical system of some or all glass or plastic lenses, all diffusers, all refractors and shaping diffusers (holographic or otherwise)

D. All mechanical adjustment systems

E. All plastic or aluminum reflector/refractor Beamspread is defined as the angle of light emitting from the end of the fixture.

Previously a lighting fixture installation would require the use of three or four distinct fixtures, whether round, square, asymmetric or rectangular . . . one fixture each for a narrow, medium and flood beamspread. Beamspread is further defined, but not limited to the following criteria:

Narrow Beam Spread

Medium Beam Spread

Flood

Wide Flood

Wallwash Beam Spreads Beamspread can be more closely defined by the Illumination Engineering Society (IESNA) Type I, II, III, IV or V, square, rectangular, asymmetric or round.

### BACKGROUND

1. Field of the Invention

The invention is to provide a module to retrofit into an existing housing or as a new fixture installation. This light source is not exclusive to any light emitting source and could be from any manufactured lamp apparatus including incandescent, halogen, ceramic metal halide, high pressure sodium, metal halide, xenon, LED (Light Emitting Diode—AC or DC) and compact fluorescent lamps. The fixture has a mechanical, contractor friendly, mechanical adjustment through an optical system (i.e., reflector/refractor, filter and/or lens) within the fixture providing all range of beamspreads. Control and adjustment could be by means of a lever, screw, brackets and/or adjustment rings with specific stop points at specific beamspread with or without continuous beamspread adjustment. The lighting designer now only needs to specify one fixture for the entire project and adjust the beamspread in the field by way of the mechanical adjustment system. If they get their layout & projection incorrect, a simple mechanical field adjustment of the installed fixture is all that is necessary. A second adjustment is the ability to tilt to the side or move the centerline of the fixture to an offset position in order to wallwash a wall with light. The buyer has to buy one adjustable fixture thus standardizing the product line.

2. Prior Art

Light fixtures are well known in the art. Light fixtures are used to support light sources and provide adequate visible light as defined by the circumstance in a safe and efficient manner Electrical light sources have been evolving for many years. The most recent stage of the evolution is a light source powered by high efficiency electronic ballast and/or drivers which provides high light output (lumens/footcandles) while reducing the heat generated thereby and the power utilized thereby. Some of these light sources are identified as lamp apparatus including incandescent, halogen, ceramic metal halide, high-pressure sodium, metal halide, xenon, LED (Light Emitting Diode—AC or DC), SSL (Solid State Lighting) and compact fluorescent lamps. Typically, a major investment is required to carry inventory of various fixture mixes with fixed optical performance, installation variances and no adjustability in the field. Sometimes each fixture will have a dedicated optical performance “package” associated with it. The necessity of installing a single light fixture is often times neither practical nor feasible due to illumination criteria and limitation on current fixture designs.

### SUMMARY OF THE INSTANT INVENTION

The Field Adjustable Light Fixture consists of three main components. The optical system, the optic adjustment system and the adjustable mechanisms that are use to select the desired lighting distribution.

A. The optical system may consist of glass or plastic lenses, refractors, shaping diffusers, holographic lenses, color filters and reflectors

B. The optic system mount can be manufactured of aluminum, brass, plastic or steel

C. The adjustable mechanism consists of a springs, split retainer rings, housing, retainer ring(s), lever/button/ knob, spring cylinders, geared enclosures, etc.

### BRIEF DESCRIPTION OF THE DRAWINGS

FIG. 1 is an isometric assembly view, depicting the knob/lever adjustable feature designated as the Light Fixture area A, the Optical Adjustment B, the Optical Systems C, Light Source D, and the Thermal Management E.

FIG. 2 is an exploded view of the push/pull or turning adjustable lever/button/knob that may include a fixed or removable feature (100), retainer split rings (101, 102 & 106), lens (103), diffuser-shaping or otherwise (104) adjustment retainer ring (105), coil spring (107), spring enclosure (108), reflector (109), light source (110), adjustment locator housing (111), heatsink (112) and power input (113).

FIG. 3 is a sectional view of the assemble as depicted in FIG. 2.

FIG. 4 is an isometric assembly view, depicting the twist adjustable feature fixture designated as the Light Fixture area A, the Optical Adjustment B, the Optical Systems C, Light Source D, and the Thermal Management E.

FIG. 5 is an exploded view of a rotational optics adjustment system that may include a retainer ring (200), lens (201), diffuser - shaping or otherwise (202), spiral groove/slot optical housing (203), optical housing (204), locator pins (205), fasteners (206), reflector (207), light source (208), heatsink (209) and input power (210).

FIG. 6 is a side cut-away assembled view of FIG. 5.

FIG. 7 is an isometric assembly view, depicting the gear ratchet spring loaded adjustable design fixture designated as the Light Fixture area A, the Optical Adjustment B, the Optical Systems C, Light Source D, and the Thermal Management E.

FIG. 8 is an exploded view of the gear ratchet spring loaded adjustable design that may include split retainer rings (300), lens (301), diffuser-shaping or otherwise (302), geared optical housing (303), optical housing adjustment ring with gear location tabs (304), optical housing (305), fasteners (306 & 308), reflector (307), light source (309), spiral coil spring (310), heatsink (311) and input power (312)

FIG. 9 is a side cut-away assembled view of FIG. 8.

### DESCRIPTION OF A PREFERRED EMBODIMENT

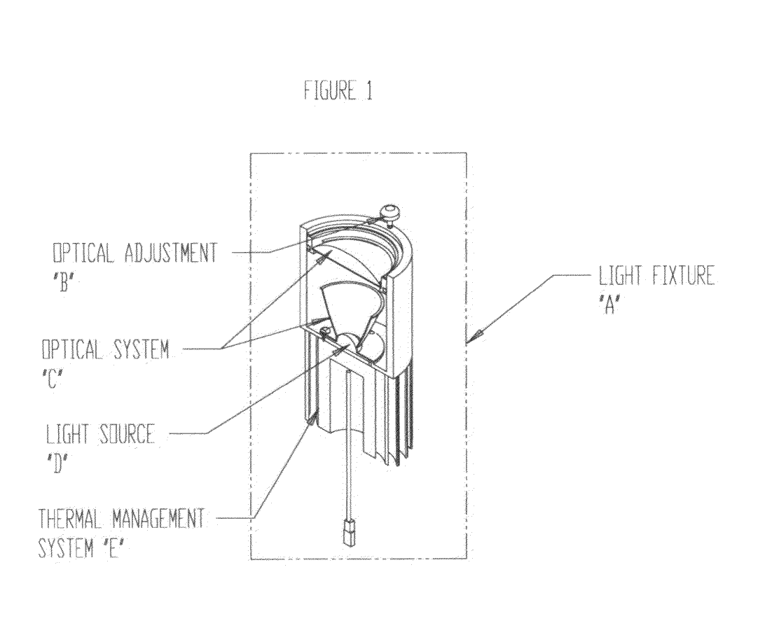

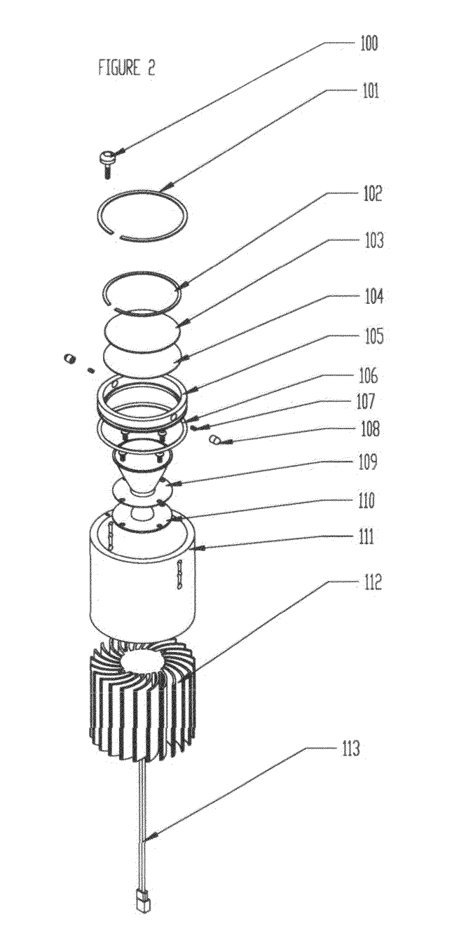

Referring now to FIGS. 1, 2 & 3, there are views of a representative adjustable light fixture design option 1 which incorporates an removable adjustment lever/button/knob to adjust the beamspread to the desired angle in conjunction with a spring loaded optical system of the instant invention. The fixture design includes an adjustment locator housing (111) with coil springs (107) encased in a spring enclosure (108) fitted into the housing to guide and lock the optical system into pre-specified beamspread angle locations, but also allowing to slide along the adjustment locator housing's groove/slot for infinite adjustment between narrow and wide flood beamspreads. The adjustment lever/button/lamb is pulled and pushed or turned to make the adjustment, then removed to keep the adjustment fixed at the designated location. By removing the lever/button/knob it is not seen in the finished installation. The lever/button/knob can be replaced and retasked to a different desire beamspread at any time.

Typically, the fixture fabricated, but limited to the following materials as reference in FIG. 2

100 ADJUSTABLE LEVER/BUTTON/KNOB of a suitable material such as aluminum, steel or plastic. The lever/button/knob has a threaded or captive end to engage the adjustment locator housing (111).

102 RETAINER SPLIT RING of suitable material such as steel or plastic—plated, painted or raw—Snapped into place above the lens (103) and diffuser (104) and held in place within a groove on the side of the adjustments retainer ring (105)

103 LENS of suitable material such as glass or plastic—Placed with the diffuser (104) inside the adjustment retainer ring (105) and held in place with retainer split ring (102)

104 DIFFUSER of suitable material such as glass or plastic—Placed with the lens (103) inside the adjustment retainer ring (105) and held in place with retainer split ring (102)

105 ADJUSTMENT RETAINER RING of suitable material such as aluminum, steel or plastic-painted, plated or raw, captivates the lens (103) & diffuser (103) and holds them in place with retainer split ring (102) and lower retainer split ring (106). Inserted in by friction press fit, swedged fit, a spring enclosure (108) with internal coil springs (107) mounted inside the adjustable retainer ring (105) rides into pre-specified beamspread angle locations, but also allowing to slide along the adjustment locator housing's groove/slot for infinite adjustment between narrow and wide flood beamspreads.

106 RETAINER RING of suitable material such as steel or plastic snaps under the lens (103 and diffuser (104) to secure them from the bottom within the adjustable retainer ring (105) 107 COIL SPRINGS of suitable material such as steel-plated, unplated, painted or raw is placed within the spring enclosure (108) and rides in the point and continuous grooves or slots in the adjustment locator housing (111) to engage optical beamspread position at fixed and non-fixed position.

108 SPRING ENCLOSURE of suitable material such as steel, aluminum or brass is inserted in the adjustable retainer ring (105) by friction press fit, swedged fit with internal spiral tension springs (107) captivated within the enclosure permitting the spring loaded enclosure rides in the point and continuous grooves or slots in the housing (111) to engage optical beamspread position at fixed and non-fixed position.

109 REFLECTOR of suitable material such as steel, aluminum, metalized or non-metalized plastic, nickel deposition, provide reflective light from the light source (110) to the optical system and is fastened by commercial available fasteners.

110 LIGHT SOURCE—as designated on page two, point 1 under Field of the Invention in the “ABSTRACT OF THE DISCLOSURE”.

111 ADJUSTMENT LOCATOR HOUSING of suitable material such as steel, aluminum or plastic to enclose the optical system comprising of items 101 through item 110. The enclosure incorporates grooves or slots to engage the optical system guided by the spring enclosure with coil spring (107 & 108) and moved in & out within the fixture by means of the adjustable lever/button/knob (100)

112 HEATSINK of suitable material such as steel, aluminum, copper, plastic to be attached to the adjustment locator housing (111) mechanically by commercially available fasteners. The heatsink absorbs and transfers heat away from the light source (110)

113 POWER INPUT of suitable material such as electrical conduit, romex wire, wire, cable, connectors/cable, connector/wire to provide the energy from the electric source to the fixture.

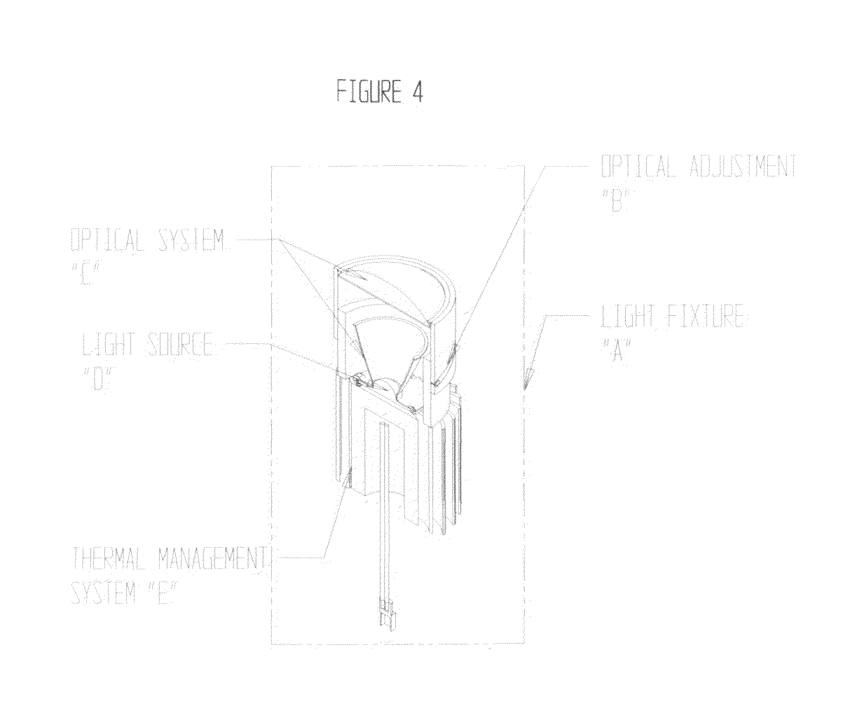

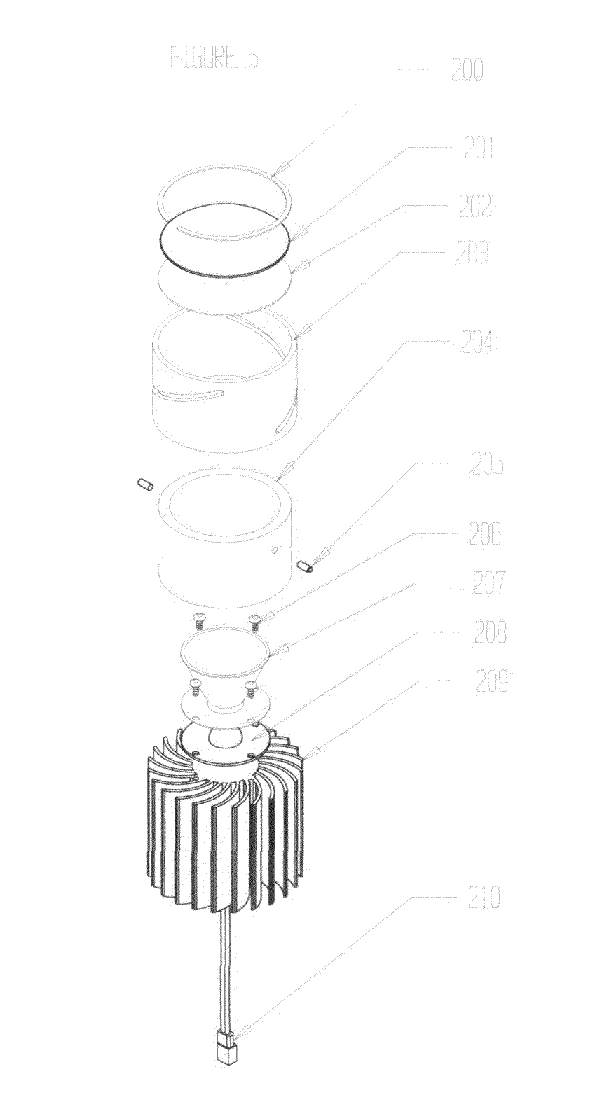

Referring now to FIGS. 4, 5 & 6, here are views of a representative adjustable light fixture design option 2, which incorporates adjustment by turning an internal pin-guided optical system riding in spiral curved slots within the fixture to adjust the beam spread to the desired beamspread of the instant invention. The fixture design includes an optical housing (204) with locator pins (205) as guides within the grooves/slots of the spiral groove/slot optical housing (203) to permit adjustment of the optical beamspread position at fixed and non-fixed position. The optical system allows the locator pins (205) to slide along the spiral groove/slot optical housing (203) for infinite adjustment between narrow and wide flood beam spread. Adjustments are made by turning the optical assembly within the fixture to the desired beamspread location. Proper tension will maintain the desired position. The fixture can be retasked to a different desire beamspread at any time.

Typically, the fixture is fabricated, but limited to the following materials as reference in FIG. 5

200 RETAINER SPLIT RING of suitable material such as steel or plastic-plated, painted or raw—Snapped into place above the lens (201) and diffuser (202) and held in place within a groove on the side of the spiral groove/slot optical housing (203).

201 LENS of suitable material such as glass or plastic—Placed with the diffuser (202) inside the spiral groove/slot optical housing (203) and held in place with retainer split ring (200).

202 DIFFUSER of suitable material such as glass or plastic—Placed with the lens (201) inside the spiral groove/slot optical housing (203) and held in place with retainer split ring (200).

203 SPIRAL GROOVE/SLOT OPTICAL HOUSING of suitable material such as aluminum, steel or plastic-painted, plated or raw—Ring captivates the lens (201) & diffuser (202) and holds them in place with retainer split ring (200). Spiral grooves or slots provide the adjustment guides for the various beamspreads

204 OPTICAL HOUSING of suitable material such as aluminum, steel or plastic-painted, plated or raw with internal locator pins (205) inserted to guide along the spiral grooves or slots in the spiral groove/slot optical housing (203) to permit adjustment of the optical beamspread position at fixed and non-fixed position.

205 LOCATOR PINS of suitable material such as aluminum, steel or plastic are pressed or swedged in to holes in the wall of the optical housing (204) as guides within the grooves/slots of the spiral groove/slot optical housing (203) to permit adjustment of the optical beamspread position at fixed and non-fixed position.

206 FASTENERS of suitable material such as steel, aluminum or plastic of standard commercial products to secure the reflector (207) & light source (208) to the heatsink (209)

207 REFLECTOR of suitable material such as steel, aluminum, metalized or non-metalized plastic, nickel deposition, provide reflective light mechanically attached by commercial fasteners (206).

LIGHT SOURCE as designated on page two, point 1 under Field of the Invention in the “ABSTRACT OF THE DISCLOSURE”.

209 HEATSINK of suitable material such as steel, aluminum, copper, plastic to be attached to the optical housing (204) mechanically by commercially available fasteners. The heatsink absorbs and transfers heat away from the reflector (207) and the light source (208).

210 POWER INPUT of suitable material such as electrical conduit, romex wire, wire, cable, connectors/cable, connector/wire to provide the energy from the electric source to the fixture.

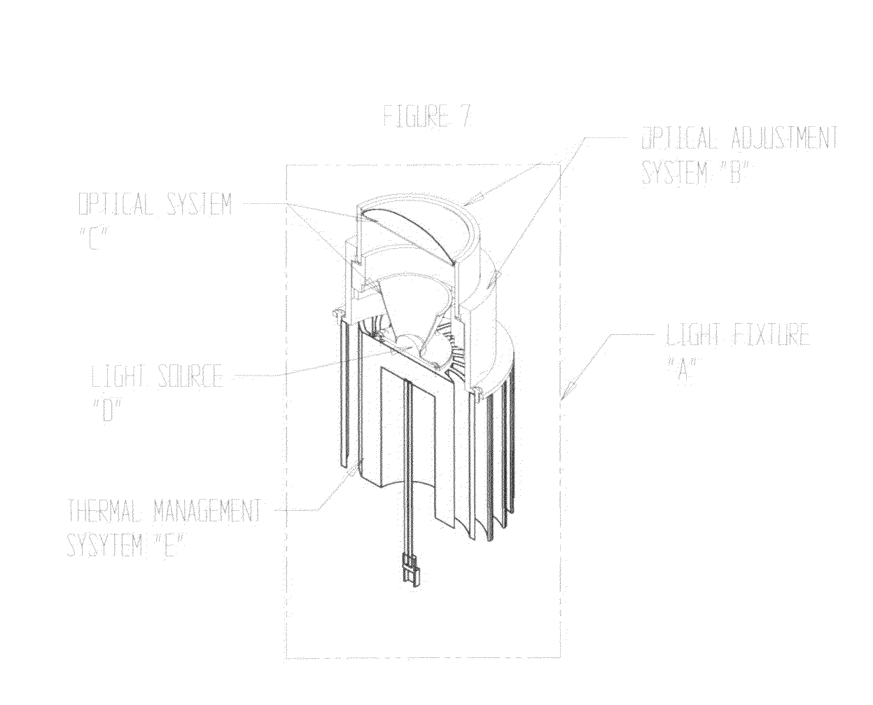

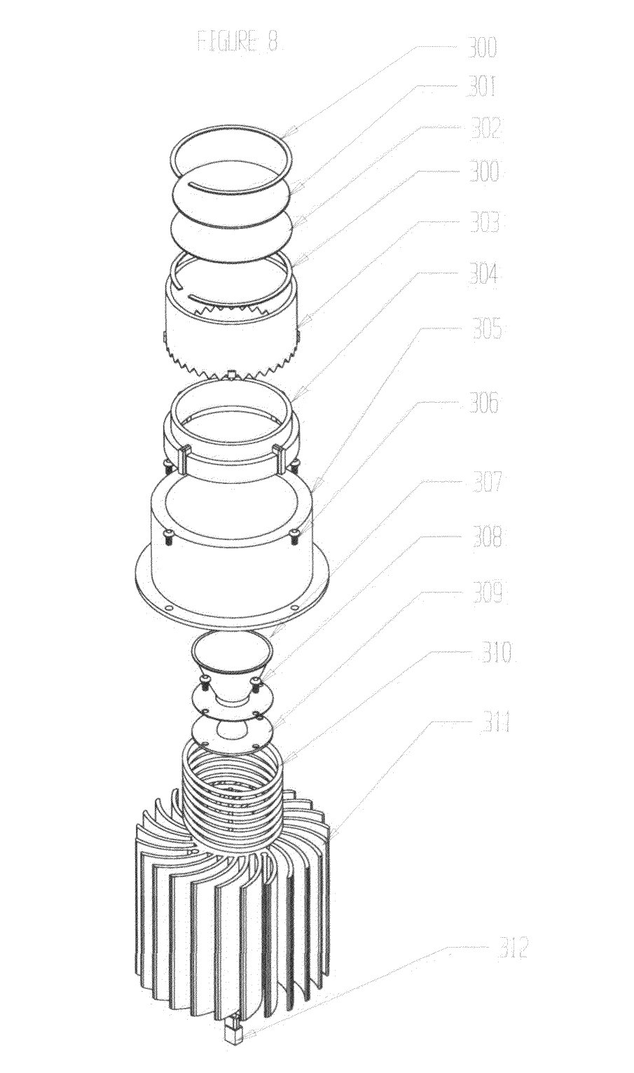

Referring now to FIGS. 7, 8 & 9, here are views of a representative adjustable light fixture design option 3 which incorporates adjustment pushing on the exposed end of the optical system assembly which is spring loaded to multiple geared stops within the fixture to adjust the beamspread to the desired beamspread of the instant invention. The fixture design includes a optical system C which included optical housing (305) with the geared optical housing (303) with the lens (302), diffuser (303) captured as the optical adjustment B sub-assembly utilizing the split retainer rings (300), with the optical adjustment ring (304). The assembly also includes the spiral coiled spring (310), which permits adjustment of the optical beamspread positions between narrow and wide flood beamspreads. Adjustments are made by pushing on the optical assembly within the fixture to the desired beamspread location. When the cycle of pushing in reaches the bottom or last gear, it will spring back to the narrow beam beginning or default position. The fixture can be retasked to a different desire beamspread at any time.

Typically, the fixture fabricated, but limited to the following materials as reference in FIG. 8

300 RETAINER SPLIT RINGS of suitable material such as steel or plastic-plated, painted or raw—Snapped into place above the lens (301) and diffuser (302) and held in place within a groove on the side of the geared optical housing (303).

301 LENS of suitable material such as glass or plastic—Placed with the diffuser (302) inside the spiral groove/slot optical housing (303) and held in place with retainer split rings (300).

302 DIFFUSER of suitable material such as glass or plastic—Placed with the lens (301) inside the spiral groove/slot optical housing (303) and held in place with retainer split rings (300).

303 GEARED OPTICAL HOUSING of suitable material such as aluminum, steel or plastic-painted, plated or raw—Ring captivates the lens (301) & diffuser (302) and holds them in place with retainer split rings (300). Graduated gears at the bottom of part provides the adjustment guides for the various beamspreads.

304 OPTICAL ADJUSTMENT RING of suitable material such as aluminum, steel or plastic-painted, plated or raw to engage and lock against the spiral coil spring (310) at the bottom & force engagement & disengagement with the geared optical housing (303). When pushed inward from the face, the system locks in and permits adjustment of the optical beamspread position. When the cycle of pushing in reaches the bottom or last gear, it will spring back to the narrow beam beginning or default position.

305 OPTICAL HOUSING of suitable material such as aluminum, steel or plastic-painted, plated or raw encloses the geared optical housing (303) with the lens (302), diffuser (303) captured as the optical adjustment B sub-assembly utilizing the split retainer rings (300), with the optical adjustment ring (304) to form the optical system C assembly which, along with the spiral coiled spring (310) permits adjustment of the optical beamspread positions.

306 & 308 FASTENERS of suitable material such as steel, aluminum or plastic of standard commercial products to secure the optical housing (305), reflector (307), light source (309) to the heatsink (311).

307 REFLECTOR of suitable material such as steel, aluminum, metalized or non-metalized plastic, nickel deposition, provide reflective light mechanical attached by commercial fasteners (306).

309 LIGHT SOURCE—as designated on page two, point 1 under Field of the Invention in the “ABSTRACT OF THE DISCLOSURE”.

310 SPIRAL COIL SPRING—of suitable material such as steel-plated or unplated to provide outward tension for the geared optical housing (303) and the optical adjustment ring (304) to securely engage within the optical housing (305).

311 HEATSINK of suitable material such as steel, aluminum, copper, plastic to be attached to the optical housing (305), reflector (307), light source (309) to the heatsink (311) by commercially available fasteners. The heatsink absorbs and transfers heat away from the reflector/light source (307, 308).

312 POWER INPUT of suitable material such as electrical conduit, romex wire, wire, cable, connectors/cable, connector/wire to provide the energy from the electric source to the fixture.

1. The invention is to provide a module to fit into an existing housing, retrofit housing or a new fixture installation. This light source is not exclusive to any light emitting source and could be from any manufactured lamp apparatus including incandescent, halogen, ceramic metal halide, high pressure sodium, metal halide, xenon, LED (Light Emitting Diode—AC or DC), SSL (Solid State Lighting) and compact fluorescent lamps. The fixture has a mechanical, contractor friendly, mechanical adjustment through an optical system (i.e., reflector/refractor, filter and/or lens) within the fixture providing all beamspreads. Control and adjustment could be by means of a lever, screw, brackets and/or adjustment rings with specific stop points at specific beamspread with or without continuous beamspread adjustment. The lighting designer now only needs to specify one fixture for the entire project and adjust the beamspread in the field by way of the mechanical adjustment system. If they get their layout & projection incorrect, a simple mechanical field adjustment of the installed fixture is all that is necessary. A second adjustment is the ability to tilt to the side or move the centerline of the fixture to an offset position in the to wallwash a wall with light. The buyer has to buy only one adjustable fixture thus standardizing the product line & reducing inventory.

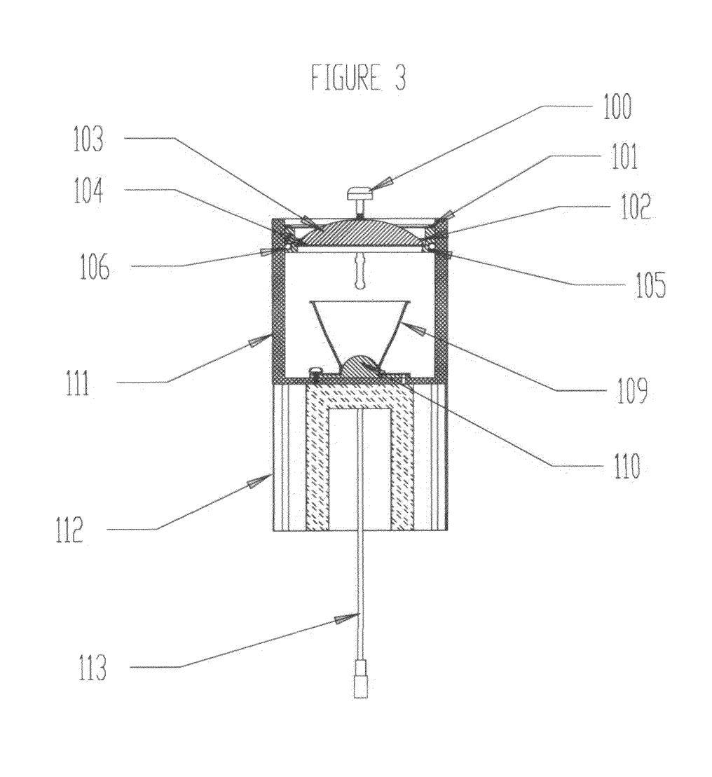

2. A lighting fixture can be installed in the field and then adjusted using an internal mechanical mechanism by screwing in or pulling up-down an adjustment lever/button/knob outside & below the fixture opening as depicted in FIGS. 1-2-3 through the range of beamspread as defined on page one paragraph two of the “ABSTRACT OF THE DISCLOSURE” utilizing a fixed reflector and movable optics.

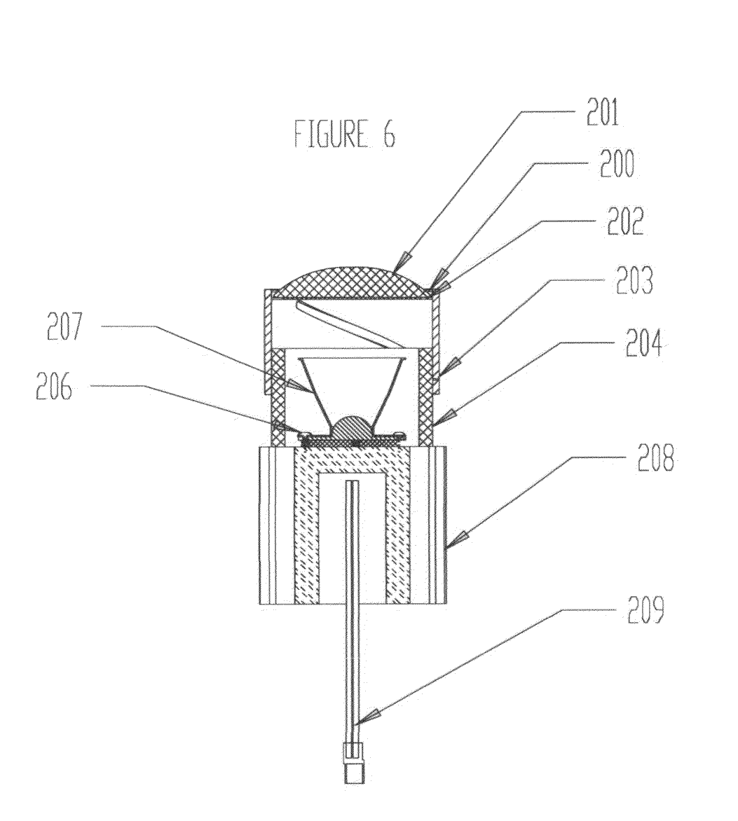

3. The fixture is recited to claim 2, but can be adjusted mechanically by turning an internal optical system riding in curved slots as depicted in FIGS. 4-5-6 within the fixture to provide various beamspread angles as defined on page one paragraph two of the “ABSTRACT OF THE DISCLOSURE”.

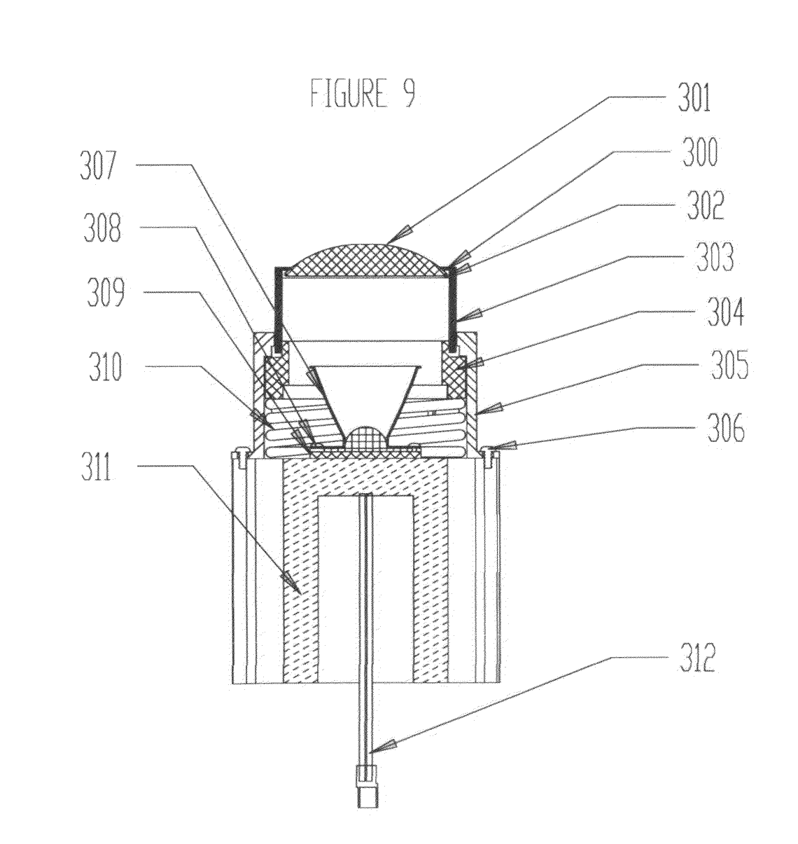

4. The fixture is recited to claim 2, but can adjusted mechanically by pushing in on the bottom of the fixture's internal optical system as depicted in FIGS. 7-8-9 riding on a spring loaded gear with designated stops to provide various range beamspread angles as defined on page one paragraph two of the “ABSTRACT OF THE DISCLOSURE” and returning to a default narrow beamspread enabling the cycle to repeat as necessary.
